(19) United States
(12) Patent Application Publication
(10) Pub. No.: US 2024/0163865 A1
(43) Pub. Date: May 16, 2024

(54) USER EQUIPMENT, BASE STATION, AND WIRELESS COMMUNICATION METHOD

(71) Applicant: JRD COMMUNICATION (SHENZHEN) LTD., Shenzhen, Guangdong (CN)

(72) Inventors: Ahmed MOHAMMED MIKAEIL, Shenzhen, Guangdong (CN); Jia SHENG, Shenzhen, Guangdong (CN)

(73) Assignee: JRD COMMUNICATION (SHENZHEN) LTD., Shenzhen, Guangdong (CN)

(21) Appl. No.: 18/550,467

(22) PCT Filed: Mar. 22, 2021
(86) PCT No.: PCT/CN2021/082089

§ 371 Date: Sep. 14, 2023

(51) Int. Cl. H04W 72/121; H04W 72/30

(52) U.S. Cl. CPC H04W 72/121; H04W 72/30

(57) ABSTRACT

A user equipment (UE), a base station, and wireless communication methods are provided. A wireless communication method performed by the UE includes indicating, to a base station, an interest on simultaneous reception of multicast/broadcast and unicast services in a same slot or different slots, being configured, from the base station, with a configuration for group scheduling via a downlink control channel, wherein the configuration for group scheduling carries a scheduling of multiplexed multicast/broadcast and unicast transmissions, and decoding the scheduling of the multiplexed multicast/broadcast and unicast transmissions to perform the simultaneous reception of the multicast/broadcast and unicast services in the same slot or the different slots. This can solve issues in the prior art, provide a group scheduling mechanism, reduce UE reception complexity, provide simultaneous reception of multicast/broadcast and unicast services, and/or provide a good communication performance.

### BACKGROUND OF DISCLOSURE

### 1. Field of the Disclosure

The present disclosure relates to the field of wireless communication systems, and more particularly, to a user equipment (UE), a base station, and wireless communication methods, which can provide radio access network configurations to support simultaneous reception of multicast/broadcast and unicast services.

### 2. Description of the Related Art

Wireless communication systems are widely deployed to provide various types of communication content such as voice, video, packet data, messaging, broadcast, and so on. These wireless communication systems may be capable of supporting communication with multiple users by sharing available system resources (e.g., time, frequency, and power). Examples of such multiple-access systems include fourth generation (4G) systems such as long term evolution (LTE) systems and fifth generation (5G) systems which may be referred to as new radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipments (UEs). A wireless communication network may include a base station that can support communication for a UE. The UE may communicate with the base station via downlink (DL) and uplink (UL). The DL refers to a communication link from the base station to the UE, and the UL refers to a communication link from the UE to the base station.

In a 3rd generation partnership project (3GPP) cellular network, broadcast and multicast services may be transported via a transport service called multimedia broadcast/multicast service (MBMS). A broadcast multicast service center (BM-SC) server is responsible to disseminate a media content to a group of subscribers. When a UE moves out of a network coverage, the UE may be unable to use the MBMS because uplink and downlink connections to the BM-SC server are no longer available. MBMS is a point-to-multipoint (PTM) interface specification designed to provide efficient delivery of broadcast and multicast services within 3GPP cellular networks. Examples of MBMS interface specifications include those described in universal mobile telecommunication system (UMTS) and long term evolution (LTE) communication specifications. For broadcast transmission across multiple cells, the specifications define transmission over single-frequency network configurations. Intended applications include mobile TV, news, radio broadcasting, file delivery, emergency alerts, and others. When services are broadcasted by MBMS, all cells inside a multimedia broadcast/multicast service single frequency network (MBSFN) area transmit the same MBMS service.

Users access these services and obtain the MBMS content through wireless communication devices such as cellular phones, tablets, laptops, and other devices with wireless transceivers that communicate with the base station within the communication system. The base station provides wireless service to the wireless communication devices, sometimes referred to as mobile devices or UEs, within cells. A user can access at least some multimedia services through a UE using either a point-to-point (PTP) connection or a PTM transmission. In 3GPP systems, PTP services can be provided using unicast techniques and PTM transmissions can be provided using MBMS communication, transmitted over an MB SFN or single cell point to multipoint (SC-PTM) communication. In systems operating in accordance with a revision of 3GPP long term evolution (LTE) communication specification, MBMS is provided using eMBMS. Accordingly, an MBMS service can be provided using either unicast service, MB SFN, or SC-PTM in an LTE system.

In radio access network (RAN) meeting #88-e held during Jun. 29, 2020 to Jul. 3, 2020, a new working item was approved to target a RAN support of multicast/broadcast services (MBS) in 5G. Aims of this working item is to provide the support in RAN to enable general MBS services over 5GS to support different MBS services such as public safety and mission critical, V2X applications, transparent IPv4/IPv6 multicast delivery, IPTV, software delivery over wireless, group communications, and IoT applications. One of key objectives of this RAN working item is to study and specify the support for basic mobility with service continuity for 5G new radio (NR) multicast/broadcast services (MBS).

During recent 3GPP meetings (RAN-104e and RAN-113e), there were wide discussions on group scheduling issues for NR MBS. The discussions have covered several topics related to MBS group scheduling solutions such as a mapping between Quality-of-service (QoS) flows of an MBS session to a radio network temporary identifier (RNTI) and radio bearers as well as multiplexing/de-multiplexing of an MBS radio link control (RLC) bearer and logical channel to transport a channel at a (media access layer) MAC layer. These proposals have discussed RAN2 enhancements to handle the group scheduling issue for MBS service separately without taking the support of simultaneous operation with unicast into account.

For example these proposals have discussed a separate type of between MBS sessions flows and the radio network temporary identifiers (RANTIs), a separate mapping between an MB S QoS flows and an MBS radio bearers, and a separate multiplexing/de-multiplexing of MAC (service data unit) SDUs and program data units (PDUs) as well as a separate mapping of the logical channels and transports for MBS service without taking the support of simultaneous operation of MB S with unicast into consideration. Under such a separate scheduling approach, a network such as a base station configures a UE with at least two RNTIs at the same time (i.e., one for unicast e.g., C-RNTI and the second one form MBS e.g., g-RNTI) if the UE is interested to receive the MBS and the unicast service in simultaneously. This could relatively increase UE reception complexity due to monitoring of more than one RNTI at a time.

Therefore, there is a need for a user equipment (UE), a base station, and wireless communication methods, which can solve issues in the prior art, provide a group scheduling mechanism, reduce UE reception complexity, provide simultaneous reception of multicast/broadcast and unicast services, and/or provide a good communication performance.

### SUMMARY

An object of the present disclosure is to propose a user equipment (UE), a base station, and a wireless communication method, which can solve issues in the prior art, provide a group scheduling mechanism, reduce UE reception complexity, provide simultaneous reception of multicast/broadcast and unicast services, and/or provide a good communication performance

In a first aspect of the present disclosure, a wireless communication method performed by a user equipment (UE) comprises indicating, to a base station, an interest on simultaneous reception of multicast/broadcast and unicast services in a same slot or different slots, being configured, from the base station, with a configuration for group scheduling via a downlink control channel, wherein the configuration for group scheduling carries a scheduling of multiplexed multicast/broadcast and unicast transmissions, and decoding the scheduling of the multiplexed multicast/broadcast and unicast transmissions to perform the simultaneous reception of the multicast/broadcast and unicast services in the same slot or the different slots.

In a second aspect of the present disclosure, a wireless communication method performed by a base station comprises being indicated, from a user equipment (UE), with an interest on simultaneous reception of multicast/broadcast and unicast services in a same slot or different slots, and configuring, to the UE, a configuration for group scheduling via a downlink control channel, wherein the configuration for group scheduling carries a scheduling of multiplexed multicast/broadcast and unicast transmissions associated with the simultaneous reception of the multicast/broadcast and unicast services in the same slot or the different slots to the UE.

In a third aspect of the present disclosure, a user equipment (UE) comprises a memory, a transceiver, and a processor coupled to the memory and the transceiver. The processor is configured to indicate, to a base station, an interest on simultaneous reception of multicast/broadcast and unicast services in a same slot or different slots, the processor is configured, from the base station, with a configuration for group scheduling via a downlink control channel, wherein the configuration for group scheduling carries a scheduling of multiplexed multicast/broadcast and unicast transmissions, and the processor is configured to decode the scheduling of the multiplexed multicast/broadcast and unicast transmissions to perform the simultaneous reception of the multicast/broadcast and unicast services in the same slot or the different slots.

In a fourth aspect of the present disclosure, a base station comprises a memory, a transceiver, and a processor coupled to the memory and the transceiver. The processor is indicated, from the UE, with an interest on simultaneous reception of multicast/broadcast and unicast services in a same slot or different slots, and the processor is configured to configure, to the UE, a configuration for group scheduling via a downlink control channel, wherein the configuration for group scheduling carries a scheduling of multiplexed multicast/broadcast and unicast transmissions associated with the simultaneous reception of the multicast/broadcast and unicast services in the same slot or the different slots to the UE.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station (e.g., gNB) of communication in a communication network system according to an embodiment of the present disclosure.

FIG. 2 is a flowchart illustrating a wireless communication method performed by a user equipment (UE) according to an embodiment of the present disclosure.

FIG. 3 is a flowchart illustrating a wireless communication method performed by a base station according to an embodiment of the present disclosure.

FIG. 4 is a schematic diagram illustrating an example of a UE and a network (e.g., a base station) of simultaneous delivery and reception of multicast/broadcast and unicast services according to an embodiment of the present disclosure.

FIG. 5 is a schematic diagram illustrating an example of a wireless communication method performed by a UE and a network (e.g., a base station) for simultaneous delivery and reception of multicast/broadcast and unicast services according to an embodiment of the present disclosure.

FIG. 6 is a schematic diagram illustrating an example of a wireless communication method performed by a UE for simultaneous reception of multicast/broadcast and unicast services according to an embodiment of the present disclosure.

FIG. 7 is a schematic diagram illustrating an example of a wireless communication method performed by a network (e.g., a base station) for simultaneous delivery and reception of multicast/broadcast and unicast services according to an embodiment of the present disclosure.

FIG. 8 is a schematic diagram illustrating an example of a proposed configuration for simultaneous group scheduling according to an embodiment of the present disclosure.

FIG. 9 is a schematic diagram illustrating an example of a proposed Quality-of-service (QoS) flows to data radio bearer (DRB)/multicast/broadcast service (MBS) radio bearer (MRB) mapping according to an embodiment of the present disclosure.

FIG. 10 is a schematic diagram illustrating an example of a layer 2 configuration for simultaneous reception according to an embodiment of the present disclosure.

FIG. 11 is a schematic diagram illustrating an example of a proposed mapping of logical and transport channels according to an embodiment of the present disclosure.

FIG. 12 is a schematic diagram illustrating an example of a mapping of MBS and unicast transport and physical channels according to an embodiment of the present disclosure.

FIG. 13 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Multicast/broadcast services (MBSs) are expected to cover diversity of 5G applications and services ranging from public safety, mission critical, V2X, transparent IPv4/IPv6 multicast delivery, IPTV, software delivery over wireless to group communications and IoT applications. As a part of 5G NR R17 standardization, a new working item is approved WID [RP-201308] targeting the RAN support of MBS. One of the main objectives of working item it to study and specify a group scheduling mechanism to allow UEs to receive broadcast/multicast service from RAN1 and RAN2 standardization perspectives. This objective includes specifying necessary the enhancements that are required to enable simultaneous operation of MBS with unicast reception. From RAN1 perspective, there is a discussion on the support of simultaneous reception of unicast services (i.e., scheduled by receiving a point to point (PTP) transmission over physical downlink shared channel (PDSCH)) and multicast/broadcast services (scheduled by either receiving PTP over PDSCH or point to multipoint (PTM) transmission over group-common PDSCH (i.e., gc-PDSCH)) multiplexed in time (e.g., in a slot) and/or in frequency domain (bandwidth part (BWP) and/or specific set of frequency resources). As for RAN2, most of the proposals submitted to MBS scheduling agenda during the latest RAN2 meeting (i.e., RAN2 113e) have discussed RAN2 enhancements to handle the group scheduling issue for MBS service separately without taking the support of simultaneous operation of MBS with unicast into account. For example, these proposals have discussed a separate mapping between MBS QoS flows and MBS radio bearers, and a separate multiplexing/de-multiplexing of MAC (service data unit) SDUs and program data units (PDUs) as well as a separate mapping of the logical channels and transports for MBS service without taking the support of simultaneous operation of MBS with unicast into consideration. Under the assumption of such kind of separate group scheduling approach for MBS, a network provides at least one of the followings on of the following service delivery configuration for UE at any given time (See Table 1). 1. Unicast service delivery of which could be scheduled using C-RNTI, 2. MBS service delivery which could be scheduled using g-RNTI, and/or 3.

Simultaneous delivery of MBS and unicast service which could be scheduled by C-RNTI and C-RNTI/g-RNTI.

TABLE 1
RNTI configuration for simultaneous reception

| Unicast Reception | MBS Reception | Simultaneous |
|---|---|---|
| Unicast [PTP] | Multicast/Broadcast | Unicast [PTP] + Multicast/ |
| | [PTM/PTP] | Broadcast [PTM/PTP] |
| C-RNTI | g-RNTI/C-RNTI | 1. C-RNTI and C-RNTI |
| | | 2. C-RNTI and g-RNTI |

As from the UE perspective, the simultaneous reception can be divided into two types of UEs: 1. A simultaneous reception of unicast and MBS scheduling/transmission in the same slot. 2. A simultaneous reception of unicast and MBS scheduling/transmission unicast and MBS in different slots.

For UE supporting or interested in simultaneous reception of unicast and MBS scheduling in different slots, the network can configure two different RNTIs for reception of each service separately in each slot. As for UE supporting interested in simultaneous reception in the same slot, the network configures at least two RNTIs for scheduling within the same slot (one for unicast transport block and the second one form MBS transport block) for a UE to support the simultaneous MBS and reception. Under such configuration, it is assumed that the MAC layer of UE is capable of receiving some transport blocks scrambled with C-RNTI followed by some transport blocks scrambled with G-RNTI and vice versa without any prior explicitly. However, such an assumption could introduce too much added complexity on UE even if we assume that UE is capable of monitoring both unicast and MBS RNTIs at the same time. Therefore, a separate scheduling configuration for unicast and MBS as discussed in above could relatively increase UE reception complexity. Some embodiments of the present disclosure provide a group scheduling mechanism to address this issue.

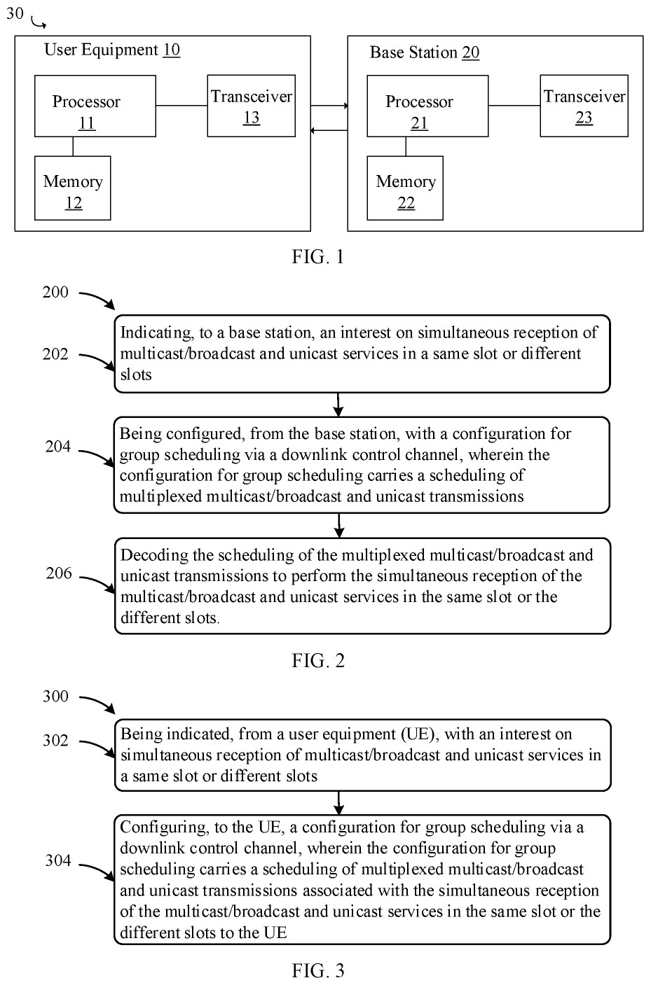

FIG. 1 illustrates that, in some embodiments, one or more user equipments (UEs) 10 and a base station (e.g., gNB) 20 for communication in a communication network system 30 according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to indicate, to the base station 20, an interest on simultaneous reception of multicast/broadcast and unicast services in a same slot or different slots, the processor 11 is configured, from the base station 20, with a configuration for group scheduling via a downlink control channel, wherein the configuration for group scheduling carries a scheduling of multiplexed multicast/broadcast and unicast transmissions, and the processor 11 is configured to decode the scheduling of the multiplexed multicast/broadcast and unicast transmissions to perform the simultaneous reception of the multicast/broadcast and unicast services in the same slot or the different slots. This can solve issues in the prior art, provide a group scheduling mechanism, reduce UE reception complexity, provide simultaneous reception of multicast/broadcast and unicast services, and/or provide a good communication performance.

In some embodiments, the processor 21 is indicated, from the UE 10, with an interest on simultaneous reception of multicast/broadcast and unicast services in a same slot or different slots, and the processor 21 is configured to configure, to the UE 10, a configuration for group scheduling via a downlink control channel, wherein the configuration for group scheduling carries a scheduling of multiplexed multicast/broadcast and unicast transmissions associated with the simultaneous reception of the multicast/broadcast and unicast services in the same slot or the different slots to the UE 10. This can solve issues in the prior art, provide a group scheduling mechanism, reduce UE reception complexity, provide simultaneous reception of multicast/broadcast and unicast services, and/or provide a good communication performance.

FIG. 2 illustrates a wireless communication method 200 performed by a user equipment (UE) according to an embodiment of the present disclosure. In some embodiments, the method 200 includes: a block 202, indicating, to a base station, an interest on simultaneous reception of multicast/broadcast and unicast services in a same slot or different slots, a block 204, being configured, from the base station, with a configuration for group scheduling via a downlink control channel, wherein the configuration for group scheduling carries a scheduling of multiplexed multicast/broadcast and unicast transmissions, and a block 206, decoding the scheduling of the multiplexed multicast/broadcast and unicast transmissions to perform the simultaneous reception of the multicast/broadcast and unicast services in the same slot or the different slots. This can solve issues in the prior art, provide a group scheduling mechanism, reduce UE reception complexity, provide simultaneous reception of multicast/broadcast and unicast services, and/or provide a good communication performance.

FIG. 3 illustrates a wireless communication method 300 performed by a base station according to an embodiment of the present disclosure. In some embodiments, the method 300 includes: a block 302, being indicated, from a user equipment (UE), with an interest on simultaneous reception of multicast/broadcast and unicast services in a same slot or different slots, and a block 304, configuring, to the UE, a configuration for group scheduling via a downlink control channel, wherein the configuration for group scheduling carries a scheduling of multiplexed multicast/broadcast and unicast transmissions associated with the simultaneous reception of the multicast/broadcast and unicast services in the same slot or the different slots to the UE. This can solve issues in the prior art, provide a group scheduling mechanism, reduce UE reception complexity, provide simultaneous reception of multicast/broadcast and unicast services, and/or provide a good communication performance.

In some embodiments, the base station 20 configures the configuration for group scheduling is based on the interest on the simultaneous reception of the multicast/broadcast and unicast services in the same slot or the different slots from the UE 10 and/or based on a type of a scheduling mode for simultaneously delivery from a network configuration. In some embodiments, the base station 20 configures the configuration for group scheduling comprising mapping between QoS flows of an MBS session to an RNTI and one or more DRB s/MRBs as well as a multiplexing/de-multiplexing of a logical channel and a transport channel at a MAC layer for each scheduling mode. In some embodiments, the configuration for group scheduling comprises a new radio (NR) layer 3 multicast/broadcast service (MBS) configuration, in the NR layer 3 MBS configuration, the base station 20 maps quality-of-service (QoS) flows associated with the multicast/broadcast service (MBS) that the UE 10 is interested to be received simultaneously with the unicast service, to one or more MBS radio bearers (MRBs) and/or one or more unicast data radio bearers (DRBs); the base station 20 sets the one or more MRBs to use a point-to-point (PTP) transmission and/or a point-to-multipoint (PTM) transmission, and the base station 20 sets the one or more unicast DRBs to use the PTP transmission. In some embodiments, in the NR layer 3 MBS configuration, the base station 20 maps the one or more MRBs and/or the one or more unicast DRBs using a single RNTI for the simultaneous reception of the multicast/broadcast and unicast services.

In some embodiments, in the NR layer 3 MBS configuration, the base station 20 provides a mapping of the MBS QoS flows and/or the RNTI and/or the one or more MRBs and/or the one or more unicast DRBs at a service data adaptation protocol (SDAP) layer to support the simultaneous reception of the multicast/broadcast and unicast services for the UE 10. In some embodiments, the configuration for group scheduling comprises a NR layer 2 MBS configuration, in the NR layer 2 MBS configuration, the base station 20 performs mapping between MRB and DRB data packets at a packet data convergence protocol (PDCP) layer, and routes/switches MRB PDCP data packets between different radio link control (RLC) entities and/or segments at the PDCP layer. In some embodiments, in the NR layer 2 MBS configuration, the base station 20 routes/switches the MRB PDCP data packets associated with the MBS that the UE 10 is interested to be received simultaneously by using a point to point unicast (PTP-MBS) RLC segment. In some embodiments, in the NR layer 2 MBS configuration, when the base station 20 maps the MRB PDCP data packets associated with the MBS service that the UE 10 is interested to be received simultaneously with the unicast service into the one or more DRBs by the SDAP layer, the base station 20 schedules the MRB PDCP data packets by using a PTP unicast (PTP-U) UM RLC segment and/or a PTP-MBS UM RLC segment.

In some embodiments, in the NR layer 2 MBS configuration, the base station 20 provides a multiplexing between media access control (MAC) service data units (SDUs) and packet data units (PDUs) and a mapping between MAC transports and a logical channel at a MAC layer to support the simultaneous reception of the multicast/broadcast and unicast services for the UE 10. In some embodiments, in the NR layer 2 MBS configuration, the base station 20 multiplexes PTP multicast (PTP-U) SDUs of the MRB PDCP data packets mapped over the PTP-MBS UM RLC segment with PTP-U SDUs of the MRB PDCP data packets or PTP-U SDUs of one or more of the DRBs scheduled by using the PTP-U UM RLC segment and/or the PTP-MBS UM RLC segment. In some embodiments, in the NR layer 2 MBS configuration, the base station 20 maps PTM SDUs of MRB data packets mapped over a PTM UM RLC segment to a PTM MAC PDU. In some embodiments, in the NR layer 2 MBS configuration, the base station 20 maps an MBS traffic logical channel (MTCH), an MBS control logical channel (MCCH), a unicast/MBS dedicated traffic channel (DTCH), and a unicast/MBS control traffic channel (DCCH) to a unicast downlink shared channel (DL-SCH). In some embodiments, the base station 20 allocates the DL-SCH carries a MAC-PDU, and the same logical channel identifier (LCID) space for the MBS MTCH, the MBS MCCH, the unicast/MBS DTCH, and the unicast/MBS DCCH for combining across PTP-U PDUs and PTP-MBS/PTM PDUs.

In some embodiments, in the NR layer 2 MBS configuration, the base station 20 maps an MBS MTCH and an MBS MCCH to a multicast channel (MCH). In some embodiments, the MCH carries a PTM MAC PDU and the base station 20 allocates the same LCID space of DL-SCH to the MCH for the simultaneous reception of the multicast/broadcast and unicast services for the UE 10. In some embodiments, the configuration for group scheduling comprises a NR layer 1 MBS configuration, in the NR layer 1 MBS configuration, the base station 20 provides an RNTI allocation and a bandwidth part (BWP) configuration for unicast and MBS at a physical layer to support the simultaneous reception of the multicast/broadcast and unicast services for the UE 10.

In some embodiments, in the NR layer 1 MBS configuration, the base station 20 configures at least one of the followings, and the at least one of the followings comprises that: if the unicast DL-SCH is reused for the MBS, the base station 20 configures, to the UE 10, a UE-specific physical downlink control channel (PDCCH) scrambled with a cell RNTI (C-RNTI) to schedule a physical downlink shared channel (PDSCH) carrying the MBS and a PDSCH carrying the unicast service for the simultaneous reception of the multicast/broadcast and unicast services for the UE 10; if the unicast DL-SCH is reused for the MBS, the base station 20 configures, to the UE 10, a group common PDCCH scrambled with a group common G-RTNI to schedule the group common PDSCH carrying the unicast service and the MBS for the simultaneous reception of the multicast/broadcast and unicast services at a unicast content of UEs 10 interested on the same MBS; the PDDCH carries the MBS and the PDSCH carries the unicast service for the simultaneous reception of the multicast/broadcast and unicast services to the UE 10; if the MCH is used, an MBS transport channel is switched by the base station 20 to use a UE-specific PDSCH, and the base station 20 configures, to the UE 10, the UE-specific PDCCH with a cyclic redundancy check (CRC) scrambled by the C-RNTI for the base station 20 to schedule the PDSCH carrying the MBS and the PDSCH carrying the unicast service for the simultaneous reception of the multicast/broadcast and unicast services; and/or if the MCH is used, the MBS transport channel is mapped by the base station to a group-common PDSCH, the base station 20 configures, to the UE 10, the UE-specific PDCCH with the CRC scrambled by the C-RNTI for the base station 20 to schedule the group-common PDSCH carrying the MBS, and the same UE-specific PDCCH scrambled with the C-RNTI is used for the base station 20 to schedule the PDSCH carrying the unicast service.

In some embodiments, in the NR layer 1 MBS configuration, the base station 20 configures, to the UE 10, a common frequency resource and/or an MBS specific BWP to be used for carrying the PDSCH or a group common PDSCH (gc-PDSCH) carrying the MBS. In some embodiments, in the NR layer 1 MBS configuration, the base station 20 configures, to the UE 10, a switching signal via a radio resource control (RRC) signalling, a MAC signalling, or physical signalling to help the UE 10 change a decoding configuration for reception of the group-common PDSCH carrying the MBS and the PDSCH carrying the unicast service within one slot.

In some embodiments, group scheduling is an efficient method specified for MBS transmission in the 3GPP 5G NR MBS working item. In recent 3GPP meetings discussion regard this issue, most of the proposals have focused only on discussing the MBS group scheduling enhancements to allow a UE to efficiently receive an MBS. However, given the fact that objective work item description (WID) also states that to specifying necessary enhancements required to enable simultaneous MBS and unicast reception within the context of group scheduling objective. Some embodiments of the present disclosure provide a new method that try to address the issue with a single design. More specifically, some embodiments provide a shared scheduling mechanism that allows for mapping of group scheduled MBS services into unicast RAN resources in a way that allow configuring the UE to monitor only one RNTI at a time for efficient MBS and unicast simultaneous services reception. In some embodiments, the UE exchanges some information to the network indicating it interests on simultaneous reception of MBS and unicast service. Based on the information provided information by the UE or acquired form RAN internally or the core network, the network (e.g., base station) decides a scheduling mode for simultaneous delivery of MBS and unicast service, determines the appropriate layer 1, layer 2, and layer 3 RAN level mapping and scheduling configuration to support the UE for simultaneous delivery of MBS and unicast service, for each mode. Then, the network provides a control configuration related to the simultaneous to reception to the UE via a downlink control channel. Upon the reception of configuration by the UE, the UE decodes the simultaneous reception scheduling configuration it to receive the unicast service and MBS scheduled by the network.

Advantages of the group and simultaneous broadcast/multicast and unicast scheduling mechanism provided in some embodiments of the present disclosure compared to prior art proposals submitted to RAN-13e invention include:

1. Unlike the proposals submitted to RAN-13e which only address the issue of group scheduling or address group scheduling and simultaneous reception separately, the new method of some embodiments tires to address both the simultaneous MBS and unicast reception within the context of group scheduling objective as required in objective of 5G NR MBS WID.

2. Compared to prior art proposals submitted to RAN-13e that considers a separate scheduling configuration for MBS and unicast service which cloud lead a UE to monitor more than one RNTI at the same time for simultaneous reception, the new method of some embodiments allows the UE to monitor only a single RNTI in order to receive both broadcast/multicast and unicast services simultaneously in a slot. This could relatively reduce UE reception complexity.

Further, in some embodiments, without proposed configurations, a UE could end up with to separate a network to configure the UE with at least two G-RNTIs (one for unicast service and the second form MBS) for the UE to support the simultaneous MBS and unicast reception. Such a configuration can relatively increase a UE reception complexity for UE wishing to receive the MBS and unicast service simultaneously. Some embodiments of the present disclosure provide a new scheduling mechanism to address this issue. The prior art is to follow for MBS scheduling the same configuration of unicast and separately provide the configuration for MBS without taking into account the support of simultaneous unicast reception as discussed by the prior art proposals. In addition, the prior art is not an optimal solution for two reasons. Firstly, it cannot fully address 3gpp WID requirements. Secondly, it will lead to a huge UE complexity because separate scheduling of MBS services without taking the possibility of unicast reception into account could lead the UE to monitor more than one RNTI at a time (i.e., one for unicast service and the second one form MBS) if UE is interested to receive the MBS and unicast service in simultaneously in a slot.

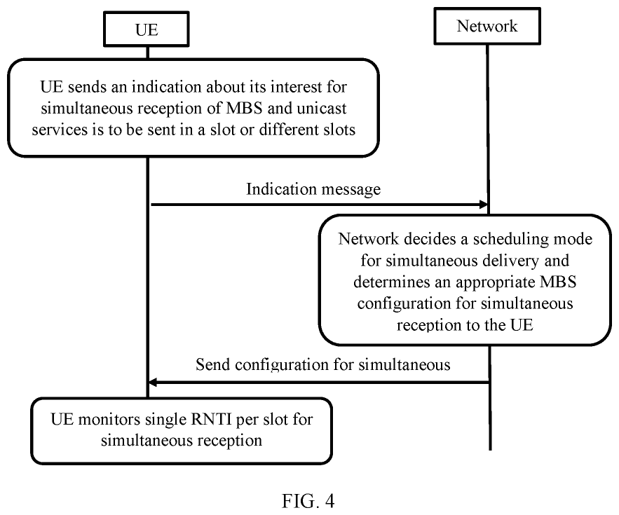

FIG. 4 illustrates an example of a UE and a network (e.g., a base station) of simultaneous delivery and reception of multicast/broadcast and unicast services according to an embodiment of the present disclosure. FIG. 4 illustrates that, in some embodiments, a UE sends an indication about its interest for simultaneous reception of MBS and unicast services is to be sent in a slot or different slots, a network decides a scheduling mode for simultaneous delivery and determines an appropriate MBS configuration for simultaneous reception to the UE, the network sends the configuration for simultaneous reception to the UE, and the UE monitors single RNTI per slot for simultaneous reception.

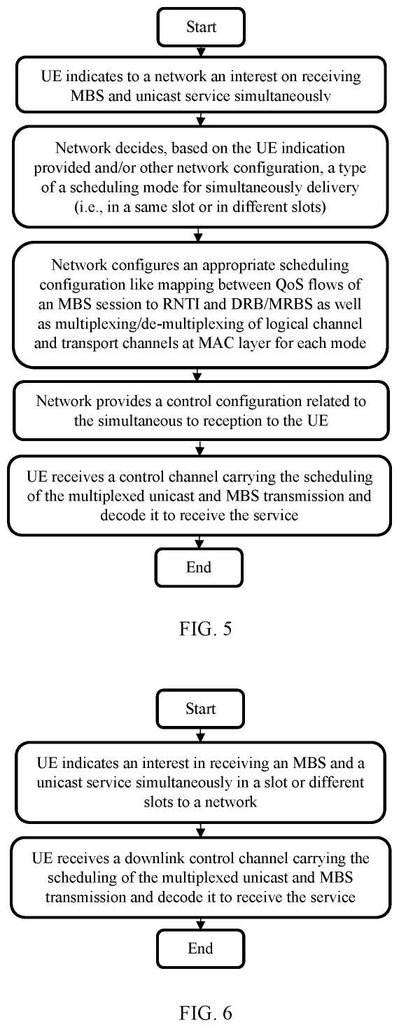

FIG. 5 illustrates an example of a wireless communication method performed by a UE and a network (e.g., a base station) for simultaneous delivery and reception of multicast/broadcast and unicast services according to an embodiment of the present disclosure. FIG. 5 illustrates that, in some embodiments, a UE indicates to a network an interest on receiving MBS and unicast service simultaneously, a network decides, based on the UE indication provided and/or other network configuration, a type of a scheduling mode for simultaneously delivery (i.e., in a same slot or in different slots), the network configures an appropriate scheduling configuration like mapping between QoS flows of an MBS session to an RNTI and a DRB/MRBS as well as multiplexing/de-multiplexing of logical channel and transport channels at a MAC layer for each mode, the network provides a control configuration related to the simultaneous to reception to the UE, and the UE receives a control channel carrying the scheduling of the multiplexed unicast and MBS transmission and decode it to receive the service.

FIG. 6 illustrates an example of a wireless communication method performed by a UE for simultaneous reception of multicast/broadcast and unicast services according to an embodiment of the present disclosure. FIG. 6 illustrates that, in some embodiments, a UE indicates an interest in receiving an MBS and a unicast service simultaneously in a slot or different slots to a network, and the UE receives a downlink control channel carrying the scheduling of the multiplexed unicast and MBS transmission and decode it to receive the service.

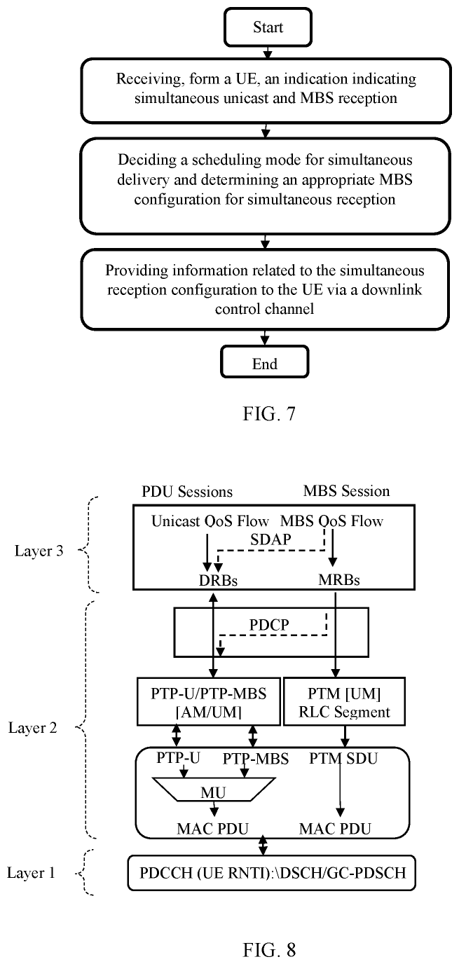

FIG. 7 illustrates an example of a wireless communication method performed by a network (e.g., a base station) for simultaneous delivery and reception of multicast/broadcast and unicast services according to an embodiment of the present disclosure. FIG. 7 illustrates that, in some embodiments, the wireless communication method performed by the network comprises receiving, form a UE, an indication indicating simultaneous unicast and MBS reception, deciding a scheduling mode for simultaneous delivery and determining an appropriate MBS configuration for simultaneous reception, and providing information related to the simultaneous reception configuration to the UE via a downlink control channel.

FIG. 4 to FIG. 7 illustrate that, in some embodiments, In order to avoid the above discussed problem and to enable simultaneous MBS and unicast reception within the context of group scheduling objective, some embodiments of the present disclosure provide a new shared scheduling method for MBS and unicast, which allows mapping of group scheduled MBS services into unicast RAN resources in a way that allows configuring the UE to monitor only one RNTI at a time for simultaneous MBS and unicast reception (as illustrated in FIG. 4 and FIG. 5). In some embodiments, the UE exchanges some information to the network to indicate the UE's interest on simultaneous reception of MBS and unicast services. Based on the information provided by the UE or acquired form RAN internally or the core network, the network decides the scheduling mode for simultaneous delivery of MBS and unicast services, determines the appropriate layer 1, layer 2 and layer 3 RAN level mapping and scheduling configuration to support UE simultaneous delivery of MBS and unicast services, for each mode. Then, the network provides the control configuration related to the simultaneous to reception to the UE. Upon the reception of configuration by the UE, the UE decodes the simultaneous reception scheduling configuration to receive the unicast and MBS services scheduled by the network (as illustrated in FIG. 6 and FIG. 7).

In some embodiments, the scheduling mode could be either unicast and MBS scheduling in the same NR time slot, or unicast and MBS scheduling in different NR time slot.

In some embodiments, if the UE reports an interest of simultaneous reception of unicast and MBS in different slots, the network uses a separate mapping for unicast session content into unicast data radio bearer (DRB), and MBS session content or QoS flows to MBS radio bearer (MRB) and configures the UE with separate RNTI for each service. For example, the networks may configure UE with C-RNTI to receive the service in first slot if the service is unicast and similarly configures the UE with g-RNTI or C-RNTI to receive service in the second slot in if it an MBS service.

In some embodiments, if UE reports an interest of simultaneous reception in the same slot, the network uses shared scheduling configurations for unicast and MBS in a way that configures the UE with only one C-RNTI to reduce complexity.

In some embodiments, in the method provided above, the shared network scheduling configurations for simultaneous delivery of MBS and unicast in a slot to UE, comprise at least layer 1, layer 2, and/or layer 3 RAN configurations which may include one or more of the configurations proposed in the following embodiments (as illustrated in FIG. 7) which could be: 1. A new mapping between session content (i.e., MBS flows) and/or RNTI and/or radio bearers at SDAP layer. 2. A routing of MRB to DRB at PDCP and RLC layer and/or 3). 3. A new type of multiplexing between MAC SDUs and PDUs and mapping between MAC transports and logical channel at MAC layer. 4. A new type of transmission scheme, RNTIs allocation and/or BWP configuration for physical channel for simultaneous unicast and MB S delivery at PHY layer.

FIG. 8 illustrates an example of a proposed configuration for simultaneous group scheduling according to an embodiment of the present disclosure. In some embodiments, the configuration for group scheduling comprises a NR layer 1 MBS configuration, a NR layer 2 MBS configuration, and a NR layer 3 MBS configuration.

Proposed layer 3 Configuration:

For NR layer 3 MBS configuration (i.e., service data adaptation protocol (SDAP)), it has been already agreed in SA2 (TR 23.737) that the following principles are applied for normative work for NR MBS services: 1. The network supports QoS control per MBS session instead of packet to UPF per user. UPF. 2. The network supports one or multiple QoS flows for an MBS session. Furthermore, in the last RAN2 meeting (3gpp WG2 R2-112e), it was also agreed that the function of mapping from QoS flows to MBS radio bearers in SDAP layer is needed for NR MBS. While in 3GPP WG2 R2-113e, it has been proposed for MBS QoS flows corresponding to an MBS session can be mapped to one or more than one MBS (PTP/PTM) radio bearers. This assumption considers a separate scheduling for MBS service without taking into account the possibility of multiplexing with unicast for simultaneous reception.

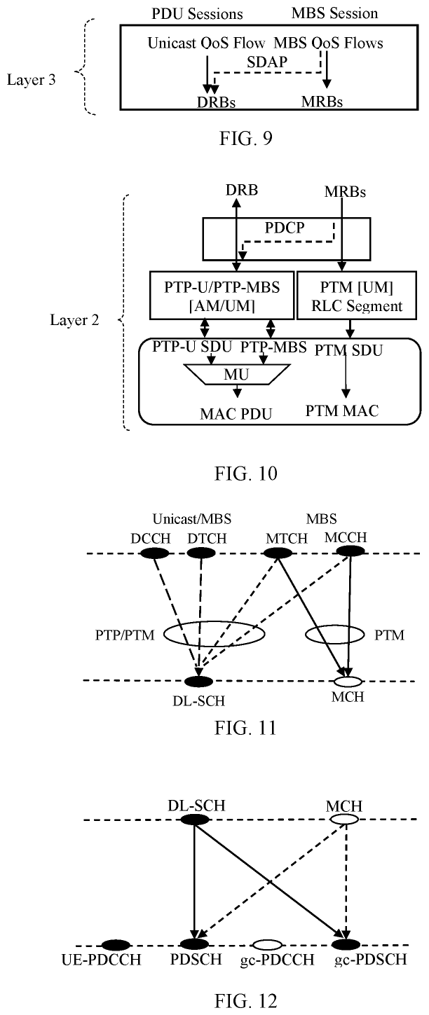

FIG. 9 illustrates an example of a proposed Quality-of-service (QoS) flows to data radio bearer (DRB)/multicast/broadcast service (MBS) radio bearer (MRB) mapping according to an embodiment of the present disclosure. In some embodiments, in order to handle the issue of MBS and unicast simultaneous reception at layer 3 while sticking to the agreed design of SA2 and RAN2, a new design of some embodiments of the present disclosure is required that considers scheduling of both unicast and MBS simultaneously for the UE interested in simultaneous reaction (as illustrated in FIG. 9). Therefore, for simultaneous MBS and unicast reception, some embodiments of the present disclosure propose the following new mapping between QoS flow and MBS radio bearer.

Proposal 1: In some embodiments, multiple MBS QoS flows corresponding to an MBS session can be mapped by a network (or called a base station) to one or more (PTP/PTM) MBS radio bearers (MRBs) or one or more (PTP) unicast data radio bearers (DRB s). The network maps these QoS flows in a way that the QoS flows associated with MBS service that the UE is interested to be received simultaneously with unicast are mapped directly into unicast DRB bearers or into MRB bearer if MRB is set to use both PTP and PTM transmissions. Based on the above mapping, both MBS and unicast radio bearers can be configured with/mapped using a single RNTI to be received simultaneously by the UE. This procedure can help the UE to avoid the reception of some transport blocks scrambled with C-RNTI (i.e., for unicast service) followed by other transport blocks scrambled with g-RNTI (i.e., for MBS) which could reduce UE MAC layers reception complexity. Another beneficial aspect of the above mapping is that it can facilities mode switching process between PTM and PTP process transmissions for UE, and the switching is decided for the UE by the network.

Proposed layer 2 configuration:

In some embodiments of the present disclosure, in layer 2, there are two possible options of network configurations to enable MBS simultaneous delivery of MBS and unicast service to a UE. These options are either to enable the simultaneous delivery at packet data convergence (PDCP) and radio link control (RLC) layers protocol entities via routing/switching of MBS data packet to the appropriate RLC segments or at media access protocol (MAC) layer entities via multiplexing of RLC bearer or MAC service data units (SDUs) into MAC program data units (PDUs).

Option 1 via routing at PDCP and RLC layer entities: According to 3gpp WG2 R2-113e agreements, a network can configure a UE with two RLC entities for MBS packets data (i.e., for MBS bearer mapped over MRB). Each RLC entity can be used to receive/transmit data by either PTP or PTM transmission mode, where the RLC entities corresponding to both PTM and PTP transmissions use RLC unacknowledged mode. In the case of simultaneous delivery of MBS and unicast is provided.

FIG. 10 illustrates an example of a layer 2 configuration for simultaneous reception according to an embodiment of the present disclosure. In the case of simultaneous delivery of MBS and unicast, the following proposals are provided.

Proposal 2(a): In some embodiments, at a PDCP layer, the network supports the routing/switching of MBS MRB PDCP data packets between RLC entities. In a way that, for MRB PDCP data packets corresponding to the MBS sessions/QoS flows which UE is interested to receive simultaneously with unicast are routed/switched into PTP-MBS UM RLC segment and scheduled only with UM unicast RLC segment (e.g., using C-RNTI). As for MRB data packets corresponding to the MBS sessions/QoS flows which already mapped into DRB by SDAP layer for simultaneous delivery, the network schedules it by either using PTP unicast (PTP-U) or PTP MBS (PTP-MBS) UM RLC segment (i.e., using C-RNTI) (as illustrated in FIG. 10).

Option 2 via multiplexing of MAC SDUs at MAC layer entities: Multiplexing of MBS PTP/PTM and unicast PTP RLC bearer or MAC SDUs of these RLC bearer into MAC PDU could be another essential option for supporting of simultaneous delivery of MBS and unicast to UE. Therefore, simultaneous unicast and MBS delivery is provided.

Proposal 2(b): The network may multiplex PTP-M SDUs of MBS data packet or MRB mapped over unicast PTP-MBS UM with unicast PTP-U SDUs or the data packet of unicast DRBs to be both scheduled using C-RNTI to UE. However, the network shall avoid multiplexing of the MAC SDUs of MBS MRB which already mapped over PTM RLC segment by SDAP and PDCP) MBS data packet with unicast PTP-U SDUs or the data packet of unicast DRB to avoid scheduling the MBS for unicast UEs who are not interested to receive it (as illustrated in FIG. 10) instead it shall be mapped directly to PTM MAC PDU. In this case the simultaneous delivery issue should be handle by the lower MAC and PHY processing such as switching transport channel for PTM PDU as will be later on.

FIG. 11 illustrates an example of a proposed mapping of logical and transport channels according to an embodiment of the present disclosure. FIG. 11 illustrates that, in some embodiments, as for logical channel mapping, an allocation of the identity for these logical channels is provided. It is still not decided yet for NR MBS whether to use an LTE like separate transport channel (MCH) or reuse unicast DL-SCH transport channel for MBS traffic at least for broadcast service. Therefore, there are two options of mapping between logical and transports channel to support simultaneous delivery of MBS and unicast service which could be stated as follow (as illustrated in FIG. 11).

Option1: The network maps both MBS traffic channel (MTCH) and MBS control channel (MCCH) as well as unicast dedicated traffic channel (DTCH) and dedicated control channel (DCCH) to unicast downlink shared channel (DL-SCH which carry MAC-PDU) and allocates the same LCID space for these MBSs and unicast channels for soft combining across PTP-U PDUs unicast and PTP-MBS/PTM PDUs at the UE side.

Option2: If a separate MBS transport channel like LTE multicast channel (MCH) is defined for NR MBS (e.g., to carry PTM MAC PDU), the network maps only the MBS traffic channel (MTCH) and MBS control channel (MCCH) into such transport channel (MCH) and let the simultaneous delivery issue to be handle by the lower MAC and PHY processing such as switching of TB of the transport channel to a unicast physical downlink channel as we will discuss later on. As for LICD allocation, the network may also allocate same LCID space with unicast DL-SCH to MCH to ease soft combining for the simultaneous reception at UE side.

Proposed layer 1 configuration:

For layer 1 network configuration, it has been agreed in RAN1 that the following scheme are supported for unicast (PTP) and MBS (PTP/PTM) transmission.

PTP transmission: For RRC_CONNECTED UEs, use UE-specific PDCCH with CRC scrambled by UE-specific RNTI (e.g., C-RNTI) to schedule UE-specific PDSCH which is scrambled with the same UE-specific RNTI.

PTM transmission scheme 1: For RRC_CONNECTED UEs in the same MBS group, use group-common PDCCH with CRC scrambled by group-common RNTI to schedule group-common PDSCH which is scrambled with the same group-common RNTI. This scheme can also be called group-common PDCCH based group scheduling scheme.

PTM transmission scheme 2: For RRC_CONNECTED UEs in the same MBS group, use UE-specific PDCCH with CRC scrambled by UE-specific RNTI (e.g., C-RNTI) to schedule group-common PDSCH which is scrambled with group-common RNTI. This scheme can also be called UE-specific PDCCH based group scheduling scheme.

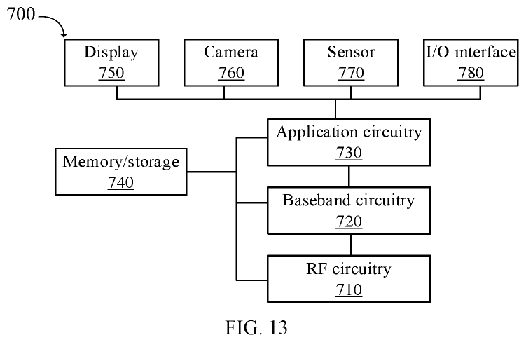

In some embodiments of the present disclosure, according to the above agreements, and the mapping and the two options of mapping between logical and transports channel, there are three possible options of network configurations to enable MBS simultaneous delivery of MBS and unicast to the UE at layer 1 (as illustrated in FIG. 12 and Table 2). In more details, FIG. 12 illustrates an example of a mapping of MBS and unicast transport and physical channels according to an embodiment of the present disclosure.

In some embodiments three possible options of network configurations to enable MBS simultaneous delivery of MBS and unicast to the UE at layer 1, these options of proposals are as follows:

Option 1: If unicast DL-SCH is reused for MBS, the network configures UE with UE-specific PDCCH scrambled with C-RNTI to schedule the PDSCH carrying MBS and the PDSCH carrying unicast for simultaneous reception at the UE side.

Option 2: If unicast DL-SCH is reused for MBS, the network configures the UE with group common PDCCH scrambled with group common G-RTNI to schedule the group common PDSCH carrying unicast and MBS for UEs interested in simultaneous reception of the same MBS a unicast content.

The PDDCH carrying MBS and the PDSCH carrying unicast for simultaneous reception to the UE are provided.

Option 3: If MCH is used, the network switches MBS transport channel (e.g., MCH TB) to use UE-specific PDSCH and configure the UE with UE-specific PDCCH with CRC scrambled by UE-specific RNTI (e.g., C-RNTI) to schedule a PDSCH carrying MBS and a PDSCH carrying the unicast service.

Option 4: If MCH is used, the network maps directly the transport channel (e.g., MCH TB) to a group-common PDSCH, and configures the UE with UE-specific PDCCH with CRC scrambled by UE-specific RNTI (e.g., C-RNTI) to schedule group-common PDSCH carrying MBS and uses the same UE-specific PDCCH scrambled with C-RNTI to schedule the PDSCH carrying the unicast service.

For options 1, 2, 3 and 4, the following proposals can apply for the physical traffic channel that carry MBS.

Proposal 5(a): In some embodiments, the network may configure either a common frequency resource such as MBS frequency region or MBS specific bandwidth part (BWP) to be used for carrying PDSCH or group common PDSCH (gc-PDSCH) that carry the MBS service.

For option 3, the following proposal is provided.

Proposal 5(b): In some embodiments, the network may optionally provide an switching signal to the UE via RRC or MAC or PHY signalling to help the UE change the decoding configuration for optimal reception of group-common PDSCH carrying the MBS and PDSCH carrying the unicast service within one slot.

TABLE 2
Possible options for simultaneous MBS and unicast delivery and reception:

| Simultaneous delivery and reception of | Simultaneous delivery and reception of |
|---|---|
| unicast (PTP) and MBS over PTP | unicast (PTP) and MBS over PTM |
| The network configures the UE with UE- | The network switches MBS transport |
| specific PDCCH scrambled with C-RNTI | channel (e.g., MCH) to use UE-specific |
| to schedule both a PDSCH carrying MBS | PDSCH and configures the UE with UE- |
| and a PDSCH carrying unicast service for | specific PDCCH with CRC scrambled by |
| simultaneous reception to the UE. | UE-specific RNTI (e.g., C-RNTI) to |
| | schedule a PDSCH carrying MBS and a |
| | PDSCH carrying unicast service. |
| | The network configures the UE with group |
| | common PDCCH scrambled with group |
| | common G-RTNI to schedule the group |
| | common PDSCH carrying unicast and MBS |
| | for UEs interested in simultaneous reception |
| | of the same MBS and unicast contents. |
| | The network maps directly the transport |
| | channel (e.g., MCH TB) to a group- |
| | common PDSCH, and configures the UE |
| | with UE-specific PDCCH with CRC |
| | scrambled by UE-specific RNTI (e.g., C- |
| | RNTI) to schedule group-common PDSCH |
| | carrying MBS and uses the same UE- |
| | specific PDCCH scrambled with C-RNTI |
| | to schedule the PDSCH carrying unicast |
| | service. |

In summary, some embodiments of the present disclosure provide a mechanism for simultaneous configuration and reception of group scheduled broadcast/multicast and unicast services in 5G NR. In some embodiments, the major innovative aspects of the mechanism compared to prior art proposals on group scheduling issue comprise one or more of the followings:
1. Unlike most of proposals submitted to RAN-13e which only address the issue of group scheduling or address group scheduling and simultaneous reception separately, the new method of some embodiments of the present disclosure tires to address both the simultaneous MBS and unicast reception within the context of group scheduling objective as required in objective of 5G NR MBS WID.
2. Compared to prior art proposals submitted to RAN-13e that consider a separate scheduling configuration for MBS and unicast which cloud led UE to monitor more than one RNTI at the same time for simultaneous reception, the new method of some embodiments of the present disclosure allows UE to monitor only a single RNTI in order to receive both broadcast/multicast and unicast services simultaneously in a slot. This could relatively reduce UE reception complexity.
3. In some embodiments of the present disclosure, a different scheduling configuration is provided according to UE interested simultaneous reception mode.
4. In some embodiments of the present disclosure, a new mapping between session content (i.e., MBS flows) and/or RNTI and/or radio bearers is provided at SDAP layer to support the simultaneous MBS and unicast delivery and reception.
5. In some embodiments of the present disclosure, a new routing of MRB to DRB is provided at PDCP and RLC layer to support the simultaneous delivery and reception of MBS and unicast.
6. In some embodiments of the present disclosure, a new type of multiplexing between MAC SDUs and PDUs and mapping between MAC transports and logical channel is provided at MAC layer to support the simultaneous delivery and reception of MBS and unicast.
7. In some embodiments of the present disclosure, for a new type of transmission scheme, RNTIs allocation and BWP configuration for unicast and MBS is provided at PHY layer to support the simultaneous delivery and reception of MBS and unicast.

Commercial interests for some embodiments are as follows. 1. Solving issues in the prior art. 2. Providing a group scheduling mechanism. 3. Reducing UE reception complexity. 4. Providing simultaneous reception of multicast/broadcast and unicast services. 5. Providing a good communication performance. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure propose technical mechanisms.

FIG. 13 is a block diagram of an example system 700 for wireless communication according to an embodiment of the present disclosure. Embodiments described herein may be implemented into the system using any suitably configured hardware and/or software. FIG. 13 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The first positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultra book, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1-46. (canceled)

47. A wireless communication method for multicast/broadcast services (MBS) and unicast services performed by a base station, comprising:
receiving, from a user equipment (UE), a message indicating an interest on reception of multicast/broadcast services and unicast services simultaneously in a same slot or different slots; and
providing, to the UE, a group scheduling configuration via a downlink control channel, wherein the group scheduling configuration carries a scheduling of multiplexed multicast/broadcast and unicast transmissions associated with the multicast/broadcast and unicast services that the UE is interested to receive.

48. The wireless communication method of claim 47, wherein the group scheduling configuration comprises mapping by the base station, QoS flows of an MBS session to an RNTI and one or more DRBs/MRBs as well as a multiplexing/de-multiplexing of a logical channel and a transport channel at a MAC layer for each scheduling mode.

49. The wireless communication method of claim 47, wherein the group scheduling configuration comprises mapping by the base station quality-of-service (QoS) flows associated with a multicast/broadcast service (MBS) which the UE is interested to received simultaneously with a unicast service, to one or more MBS radio bearers (MRBs) or to one or more unicast data radio bearers (DRBs).

50. The wireless communication method of claim 47, wherein the group scheduling configuration comprises configuring by the base station the one or more MRBs to use a point-to-point (PTP) unicast transmission or to use a point-to-multipoint (PTM) MB S transmission.

51. The wireless communication method of claim 47, wherein the group scheduling configuration comprises mapping by the base station, the one or more multicast/broadcast MRBs and the one or more unicast DRBs using a single RNTI to support UE simultaneous reception of the multicast/broadcast and unicast services.

52. The wireless communication method of claim 47, wherein the group scheduling configuration comprises routing or switching by the base station, the multicast/broadcast MRB PDCP data packets associated with the MBS service which the UE is interested to receive simultaneously unicast to use a point to point unicast (PTP-MBS) RLC segment.

53. The wireless communication method of claim 52, wherein the group scheduling configuration comprises when the base station maps the MRB PDCP data packets associated with the MBS service that the UE is interested to be received simultaneously with the unicast service into the one or more DRBs at the SDAP layer, the base station configures the MRB PDCP data packets to use a PTP unicast un-acknowledged RLC segment or a PTP MBS Un acknowledged RLC segment.

54. The wireless communication method of claim 47, wherein the group scheduling configuration comprises mapping by the base station the PTM service data units (SDUs) of MRB data packets mapped over a PTM UM RLC segment to a PTM MAC PDU segment.

55. The wireless communication method of claim 47, wherein the group scheduling configuration comprises mapping by the base station an MBS traffic logical channel (MTCH), an MBS control logical channel (MCCH), a unicast dedicated traffic channel (DTCH), and a unicast/MBS control traffic channel (DCCH) to a unicast downlink shared channel (DL-SCH) or mapping an MBS MTCH and an MBS MCCH to a multicast channel (MCH).

56. The wireless communication method of claim 47, wherein the group scheduling configuration comprises allocating by the base station for the DL-SCH carries a MAC-PDU a same logical channel identifier (LCID) space for the MBS MTCH and MBS MCCH for combining the multicast/broadcast and unicast transmissions across PTP-U PDUs and PTP-MBS/PTM PDUs.

57. The wireless communication method of claim 47, wherein the group scheduling configuration comprises allocating by the base station radio network temporary identifier (RNTI) value and a bandwidth part (BWP) configuration for unicast and MBS MAC-PDU at a physical layer.

58. The wireless communication method of claim 57, wherein the group scheduling configuration comprises the followings configuration:
if the unicast DL-SCH is used for scheduling the MBS service, the base station configures a UE-specific physical downlink control channel (PDCCH) scrambled with a cell RNTI (C-RNTI) to schedule a physical downlink shared channel (PDSCH) carrying MBS service and a PDSCH carrying unicast service for the UE;
if the unicast DL-SCH is used for scheduling the MBS, the base station configures a group common PDCCH scrambled with a group common G-RTNI to schedule the group common PDSCH carrying the unicast service and the MBS for a UEs interested on the same MB S;
if the MCH is used, the base station switches an MBS transport channel to use a UE-specific PDSCH, and configures, the UE-specific PDCCH with a cyclic redundancy check (CRC) scrambled by the C-RNTI for the base station to schedule the PDSCH carrying the MBS and the PDSCH carrying the unicast service for the simultaneous reception of the multicast/broadcast and unicast services; and/or
if the MCH is used, the base station maps MBS transport channel to a group-common PDSCH and configures a UE-specific PDCCH with the CRC scrambled by the C-RNTI for scheduling a group-common PDSCH carrying the MBS, and the same UE-specific PDCCH scrambled with the C-RNTI for scheduling a PDSCH carrying the unicast service.

59. The wireless communication method of claim 58, wherein in an NR layer 1 MBS configuration, the base station configures, to the UE, a common frequency resource and/or an MBS specific BWP to be used for carrying the PDSCH or a group common PDSCH (gc-PDSCH) carrying the MBS.

60. The wireless communication method of claim 58, wherein the group scheduling configuration comprises configuring by the base station, to the UE, a switching signal via a radio resource control (RRC) signaling, a MAC signaling, or physical signaling to assist the UE change a decoding configuration for receiving the group-common PDSCH carrying MBS and a PDSCH carrying unicast service within one slot.

61. A base station, comprising:
a memory;
a transceiver; and
a processor coupled to the memory and the transceiver;
wherein the processor is configured to execute a wireless communication method for multicast/broadcast services (MBS) and unicast services comprising:
receiving, from a user equipment (UE), a message indicating an interest on reception of multicast/broadcast services and unicast services simultaneously in a same slot or different slots; and
providing, to the UE, a group scheduling configuration via a downlink control channel, wherein the group scheduling configuration carries a scheduling of multiplexed multicast/broadcast and unicast transmissions associated with the multicast/broadcast and unicast services that the UE is interested to receive.

62. The base station of claim 61, wherein the group scheduling configuration comprises mapping by the base station, QoS flows of an MBS session to an RNTI and one or more DRBs/MRBs as well as a multiplexing/de-multiplexing of a logical channel and a transport channel at a MAC layer for each scheduling mode.

63. The base station of claim 61, wherein the group scheduling configuration comprises mapping by the base station quality-of-service (QoS) flows associated with a multicast/broadcast service (MBS) which the UE is interested to received simultaneously with a unicast service, to one or more MBS radio bearers (MRBs) or to one or more unicast data radio bearers (DRBs).

64. The base station of claim 61, wherein the group scheduling configuration comprises configuring by the base station the one or more MRBs to use a point-to-point (PTP) unicast transmission or to use a point-to-multipoint (PTM) MBS transmission.

65. The base station of claim 61, wherein the group scheduling configuration comprises mapping by the base station, the one or more multicast/broadcast MRBs and the one or more unicast DRBs using a single RNTI to support UE simultaneous reception of the multicast/broadcast and unicast services.

66. The wireless communication method of claim 61, wherein the group scheduling configuration comprises routing or switching by the base station, the multicast/broadcast MRB PDCP data packets associated with the MBS service which the UE is interested to receive simultaneously unicast to use a point to point unicast (PTP-MBS) RLC segment.
